(19) United States
(12) Patent Application Publication
(10) Pub. No.: US 2010/0253784 A1
(43) Pub. Date: Oct. 7, 2010

(54) CALIBRATION METHOD AND APPARATUS FOR AUTOMOTIVE CAMERA SYSTEM, AND METHOD AND ECU FOR DETERMINING ANGULAR MISALIGNMENTS OF AUTOMOTIVE CAMERA SYSTEM

(75) Inventor: Konevsky Oleg, Gyeonggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/487,103

(22) Filed: Jun. 18, 2009

(30) Foreign Application Priority Data
Apr. 6, 2009 (KR) 10-2009-0029342

(51) Int. Cl. H04N 17/00

(52) U.S. Cl. 348/187

(57) ABSTRACT

A method of automotive camera system calibration is disclosed in the present invention. At least two targets are placed within the field of view of each camera included in the system. Each camera captures the targets. Then, the vehicle is moved, and another image is captured. The images are used to derive the camera orientation parameters. Based on these parameters, misalignment of the cameras can be compensated by the image processing unit.

### CROSS-REFERENCE TO RELATED APPLICATIONS

This application claims the benefit of Korean Patent Application No. 10-2009-0029342 filed with the Korea Intellectual Property Office on Apr. 6, 2009, the disclosure of which is incorporated herein by reference.

### BACKGROUND OF THE INVENTION

1. Field of the Invention

The present inventive concept relates to the camera system, comprising several image sensor based camera units, attached to the vehicle in order improve the safety of driving, more specifically, a calibration method for determining angular misalignments of automotive camera system.

2. Description of the Related Art

Image sensor based cameras are becoming widely used in the vehicles. By capturing a portion of the environment surrounding the car and displaying it on the monitor in front of driver, the system enables better sense of the location and orientation of the vehicle with respect to the other objects (other vehicles, pedestrians, cyclists, buildings, trees, road and parking lot marking, etc.), improves control over the traffic situation, thus improving the safety of driving.

In order to allow the driver to observe all the surrounding of the vehicle simultaneously, the systems comprising a plurality of cameras are used. Cameras are mounted on the vehicle in such a way, that any point in the peripheral area of the vehicle is within the field of view (FOV) of at least one camera. One of the most common system architectures described in a number of publications (for instance, US patent publications US 2005/0249379, US 2003/0090570) assumes four cameras mounted as follows: front view camera (FVC)—in the grill area of the vehicle; rear view camera—(RVC)—in the boot lid or rear panel; side view cameras (SVC-R and SVC-L) in the right and left side mirror area correspondingly, as shown in the FIG. 1.

The image captured by each camera is transmitted to electronic control unit (ECU) comprising image processing mean. ECU transforms the images (eliminate “fish-eye” effect, distortion, etc.) and combines them together on a single view in such a way, that the displayed image makes an impression of being shot from above the vehicle (top view). ECU transmits the synthesized image to the display device (FIG. 2). The advantage of this approach is that the displayed image enables the driver to see the whole peripheral area around the vehicle at the same time and observe the relative location of the vehicle with respect to the external objects and parking markers in a very natural and simple form, which makes maneuvering easier and safer (FIG. 3).

However if the cameras are misaligned with respect to the vehicle and each other, the displayed image may not only look unpleasant to a human eye, but also cause confusion and misinterpretation of the distance to the object and thus deteriorate safety. FIG. 4 shows an example of the resulting image in the case of FVC misalignment.

In order to overcome this problem, manual adjustment of each camera's orientation is required. But this operation is too labor-intensive to be used on the car assembly line. On the other hand, most of the methods of camera orientation adjustment rely on the charts or targets which are positioned in the predetermined spots with respect to the vehicle. Failure in positioning the target properly results in erroneous camera orientation. Therefore, when used in the garage, these methods require high qualification of the personnel, partial disassembly of the vehicle components, large space to arrange the targets, and long time to carry out, thus increasing the cost of car service.

Moreover, the adjustable fasteners that hold camera on place but also allow changing the orientation whenever the adjustment is made, are more complex and expensive that non-adjustable rigid brackets.

The US patent publication US 2001/0012985 discloses the method of camera system calibration that allows changing the image processing on ECU in such a way, that the correct image is generated even if the cameras are misaligned. This method allows eliminating the need of mechanical camera adjustment. According to the method, target apparatus is fixed on the vehicle in such a way that the target to be captured with the camera has a predetermined position. The coordinates of the target on the image are transformed into the world coordinates, which in turn are compared to the predefined specification, thus the relative camera orientation is obtained. Then, the image processing mean is modified accordingly to compensate the camera misalignment.

This method is also of limited use on the car assembly lines, because it requires installing the target apparatus on a vehicle, at least one for each camera included in the system. On the other hand, in the garage conditions, the need for special equipment (target apparatus) to perform the calibration increases the cost of the service. Also, the design of the vehicle has to be made taking into consideration the means to mount the target apparatus with the high precision, which imposes extra restrictions and requirements and may spoil the appearance of the vehicle.

Therefore, there is a need for the method of camera system calibration that does not require the target to be placed in the predetermined position with respect to the vehicle, is fast and inexpensive enough to be carried out on the car assembly line as well as in the garage conditions, preferably automatic, invariant to vehicle dimensions and location of cameras.

### SUMMARY OF THE INVENTION

Accordingly, an advantage of the present invention is to provide the camera system calibration method that does not require attachment of any target apparatus to the body of the vehicle, is fast and inexpensive to be carried out both on the car assembly line and in the garage conditions.

According to the present invention the targets to be captured by the camera units are placed or painted on the ground in the peripheral area of the vehicle. The targets do not have to be placed precisely in any predefined position with respect to the vehicle.

Each camera unit captures the targets. Then, the vehicle is moved forward or backward, without moving the targets, and another image is captured. The vehicle may be moved on its own wheels (in this case steering wheel has to be in position ensuring motion of the vehicle along the longitudinal direction, without making a turn), on a conveyor, or any other mean. The targets are detected on both images and their coordinates on the corresponding images determined.

By calculating world coordinates of the targets before and after the displacement of the vehicle from the captured images, and comparing them to each other, the angular misalignment of each camera is determined, and the image processing parameters are modified correspondingly for each camera unit.

The advantage of the present invention is that the calibration of the camera system does not require mechanical adjustment of camera units' orientation.

Another advantage of the present invention is that the targets to be captured do not have to be located precisely in the predetermined positions with respect to the vehicle, thus eliminating the need to install target apparatus on the vehicle.

Yet another advantage of the present invention is that the calibration process can be automated and suitable for both car assembly line and garage conditions.

Yet another advantage of the present invention is that the calibration method is invariant to the vehicle dimensions, number of cameras incorporated into the system, their location on a vehicle, and may be used for a various camera systems without change.

Yet another advantage of the present invention is an apparatus capable of performing calibration process according to the calibration method disclosed thereafter. The said apparatus may be incorporated into the ECU or be a stand-alone device.

According to an aspect of the present inventive concept, there is provided a method of calibrating a camera equipped on vehicle, comprising the steps: a) capturing a first image featuring at least two targets with a camera attached to each side of the vehicle, the targets being placed in the peripheral area of the vehicle; b) displacing the vehicle in the longitudinal direction without moving the targets; c) capturing a second image featuring the targets at the displaced position; d) detecting the targets on the captured first and second images; e) calculating world coordinates of the targets based on the captured images; and f) searching for misalignment angles while optimizing a metric function based on the calculated world coordinates of the targets.

The targets are placed or painted on the ground in the peripheral area of the vehicle.

A distance between the two targets adjacent to each other in the lateral direction is maximized but still kept within a field of view of the camera.

The vehicle is configured to be displaced on its own wheels or on a conveyor or other equivalent means.

The step e) comprises calculating spherical coordinates of the chief ray entering an optical unit of the camera and world coordinates of its cross point with the ground plane.

The method further comprises adjusting chief ray spherical coordinates according to the lens optical distortion.

The step f) comprises starting the search with nominal rotation angles of a camera.

According to another aspect of the present inventive concept, there is provided a apparatus for calibrating a camera equipped on vehicle, comprising: a plurality of camera units attached to four sides of vehicle, each camera unit being configured to capture a image featuring at least two targets; and a electronic control unit configured to form a single top view by synthesizing the images captured by each of the plurality of camera units, wherein the electronic control unit determines an angular misalignment of vehicle with a method comprising the steps: a) capturing a first image featuring at least two targets per camera unit attached to a side of the vehicle, the targets being placed in the peripheral area of the vehicle; b) displacing the vehicle in the longitudinal direction without moving the targets; c) capturing a second image featuring the targets at the displaced position; d) detecting the targets on the captured first and second images; e) calculating world coordinates of the targets based on the captured images; and f) searching for misalignment angles while optimizing a metric function based on the calculated world coordinates of the targets.

The electronic control unit is incorporated into an electronic control unit already implemented in the vehicle.

The electronic control unit is a stand-alone device separated from an electronic control unit already implemented in the vehicle.

According to another aspect of the present inventive concept, there is provided a method for determining an angular misalignment of a camera equipped on vehicle, comprising: a) capturing a first image featuring at least two targets placed at one side in the peripheral area of the vehicle at a first position of the vehicle; b) capturing a second image featuring the targets at a second position away from the first position of the vehicle in the longitudinal direction; c) detecting the targets on the first and second images and obtaining their coordinates on an imager; d) initiating rotation angles α, β, γ with nominal angle values, respectively; e) calculating angles φ and θ for each of the targets at the first and second positions, the angles φ and θ defining chief ray in the spherical coordinate system whose origin coincides with world coordinate system's origin; f) calculating an affine transformation rotation matrix with current values of α, β, γ: g) calculating world coordinates for the targets at the first and second positions using the angles θ and φ, and elevation of the camera over the ground; h) calculating metric used for rotation angles optimization using the calculated world coordinates; i) updating the angles α, β, γ with optimization method until a termination criterion specific for the optimization method is met; and j) calculating misalignment angles from the differences between the undated angles α, β, γ meeting the termination criterion specific and the nominal rotation angles.

According to another aspect of the present inventive concept, there is provided a electronic control unit for determining an angular misalignment of a camera equipped on vehicle, the electronic control unit being configured to control and/or perform the steps comprising: a) at a first position of the vehicle and at a second position away from the first position of the vehicle in the longitudinal direction, capturing first and second images each featuring at least two targets placed at one side in the peripheral area of the vehicle, and in turn detecting the targets on the first and second images and then obtaining their coordinates on an imager; b) initiating rotation angles α, β, γ with nominal angle values, respectively; c) calculating angles φ and θ for each of the targets at the first and second positions, the angles φ and θ defining chief ray in the spherical coordinate system whose origin coincides with world coordinate system's origin; d) calculating an affine transformation rotation matrix with current values of α, β, γ; e) calculating world coordinates for the targets at the first and second positions using the angles θ and φ, and elevation of the camera over the ground; f) calculating metric used for rotation angles optimization using the calculated world coordinates; g) updating the angles α, β, γ with optimization method until a termination criterion specific for the optimization method is met; and h) calculating misalignment angles from the differences between the undated angles α, β, γ meeting the termination criterion specific and the nominal rotation angles.

The electronic control unit is incorporated into an electronic control unit already implemented in the vehicle, and alternatively it may be a stand-alone device separated from an electronic control unit already implemented in the vehicle.

The targets are placed or painted on the ground in the peripheral area of the vehicle.

A distance between the two targets adjacent to each other in the lateral direction is configured to be maximized but still kept within a field of view of the camera.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a vehicle with the cameras mounted on it.

FIG. 2 shows the architecture of commonly used system.

FIG. 3 shows an example of displayed image.

FIG. 4 shows an example of displayed image if one of the cameras (FVC in this particular case) is mounted with angular misalignment.

FIG. 5 illustrates world coordinate systems associated with FVC and SVC-L.

FIG. 6 illustrates coordinate system associated with the imager.

FIG. 7a and 7b illustrate an example of set-up for system calibration before and after displacement of the vehicle correspondingly.

FIG. 8 illustrates the translation of the coordinates of a point on the imager into the angle between the chief ray and optical axis using distortion curve. FOV denotes the angular field of view of the lens.

FIG. 9 illustrates the chief ray and spherical coordinate system associated with the camera.

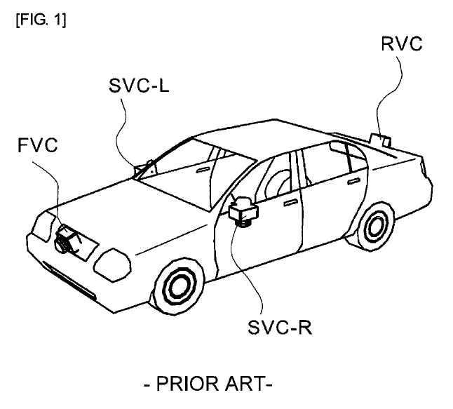

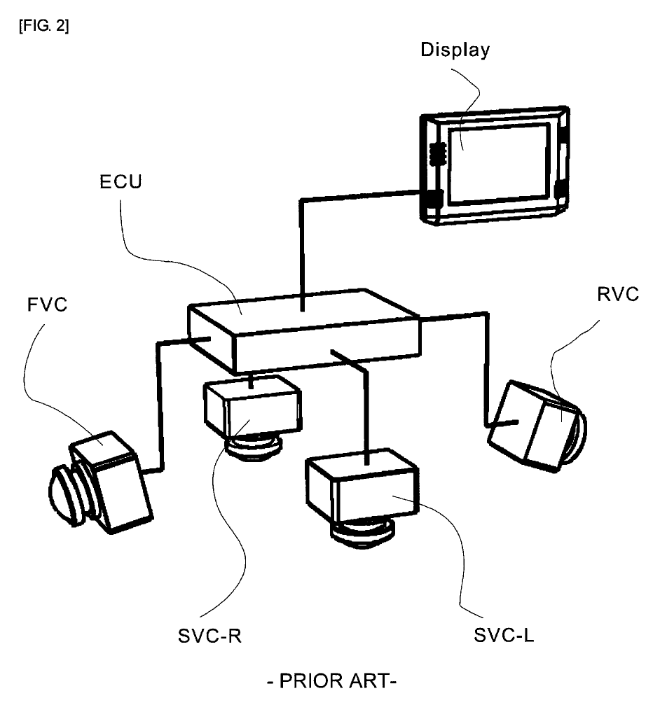

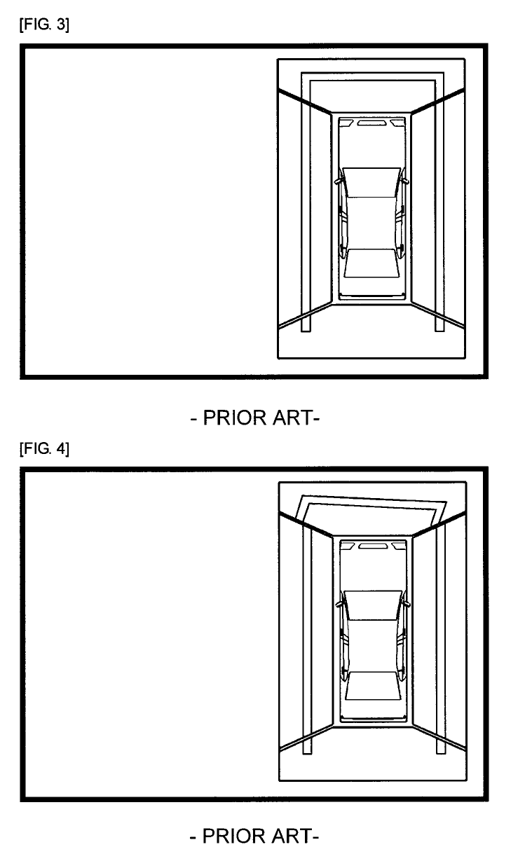

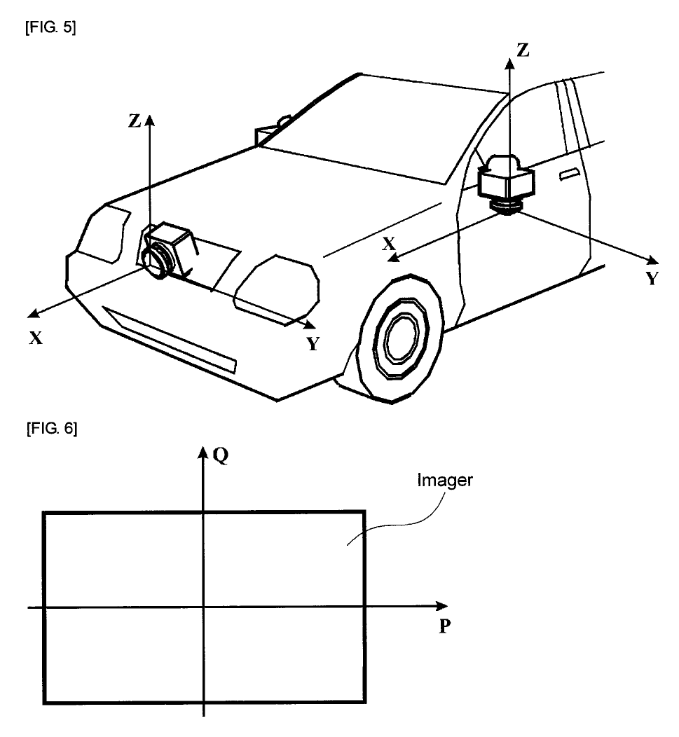

### DETAILED DESCRIPTION OF THE PREFERRED EMBODIMENTS

The present inventive concept will now be described more fully with reference to the accompanying drawings, in which exemplary embodiments of the invention are shown. The present inventive concept may, however, be embodied in many different forms and should not be construed as being limited to the embodiments set forth herein; rather, these embodiments are provided so that this disclosure will be thorough and complete, and will fully convey the concept of the invention to those skilled in the art. In the following description, well-known functions or constructions are not described in detail since they would obscure the invention in unnecessary detail.

Although terms like “first” and “second” are used to describe various elements, these elements are not limited to these terms. These terms are used only to differentiate one element from another.

Terms used herein are for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, numbers, steps, operations, elements, components, and/or groups thereof, but do not preclude the presence or addition of one or more other features, numbers, steps, operations, elements, components, and/or groups thereof.

Hereinafter, the detailed description of the invention will be provided in form of its preferred embodiment.

Meanwhile, it should be noted that, hereinafter we describe the method of calibration as it is applied to FVC only, unless otherwise is stated. The expansion of the method to RVC, SVC-R and SVC_L is straightforward.

Assumptions and Definitions

It is assumed hereinafter, that only angular misalignment requires correction, because reasonable (within tens of millimeters) error in camera location in either direction with respect to the layout does not affect the resulting top view image significantly. Moreover, the location of the camera is typically easy to control with the camera attachment mechanism (brackets, fasteners, screws, etc). Therefore, the calibration process aims to determine angular misalignment of the camera only.

Let us assume a 3-dimensional Cartesian coordinate system, hereafter called world coordinate system, is associated with the camera, and is such that the origin is at the center of the aperture stop of the lens, X axis points along the direction of the vehicle's displacement; Z—perpendicular to the ground and points upwards, Y—constitutes right-hand system with X and Z (FIG. 5).

Normal camera orientation in the world coordinate system is such that optical axis O of the lens system coincides with X, long axis of the imager is parallel to the ground. The actual camera orientation can be obtained by starting with normal camera orientation and rotating the camera about world coordinate system axes. Let α, β and γ denote rotation angles about X, Y and Z correspondingly.

Each of the angles α, β and γ is a sum of two components: nominal angle αₙₒₘ, βₙₒₘ and γₙₒₘ predefined by camera system design and known, and angular misalignment αₑᵣᵣ, βₑᵣᵣ and γₑᵣᵣ to be determined in the end of calibration process correspondingly.

When the camera is in normal position, the coordinate system X Y Z is projected onto the imager plane, thus constituting a 2-dimensional coordinate system P Q such as the axis P is a projection of axis Y, and axis Q—projection of axis Z (FIG. 6). The origin of the coordinate system P Q is nothing, but the projection of axis X.

Let P, Q be coordinate axes of a 2-dimensional system associated with the imager such that its origin coincides with the center of the imager, P is parallel to long axis of the imager, and Q—perpendicular (FIG. 6). It is further assumed that the center of the imager lies on the optical axis O of the lens system.

Acquisition of the Images

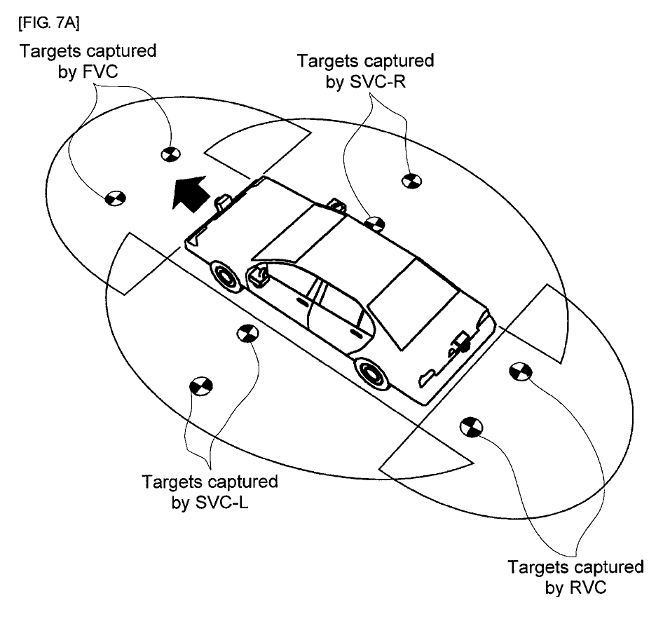

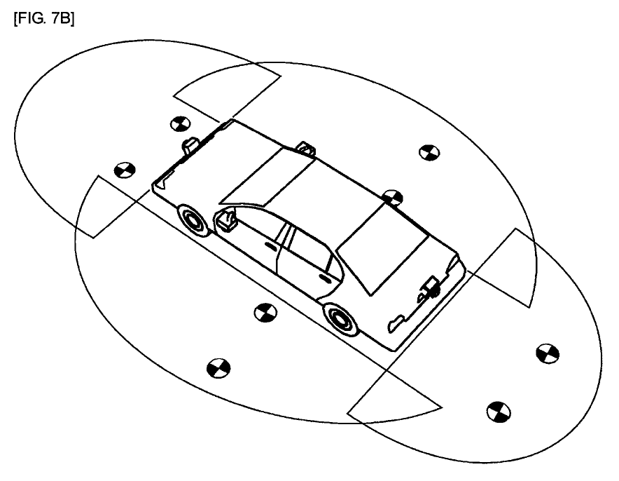

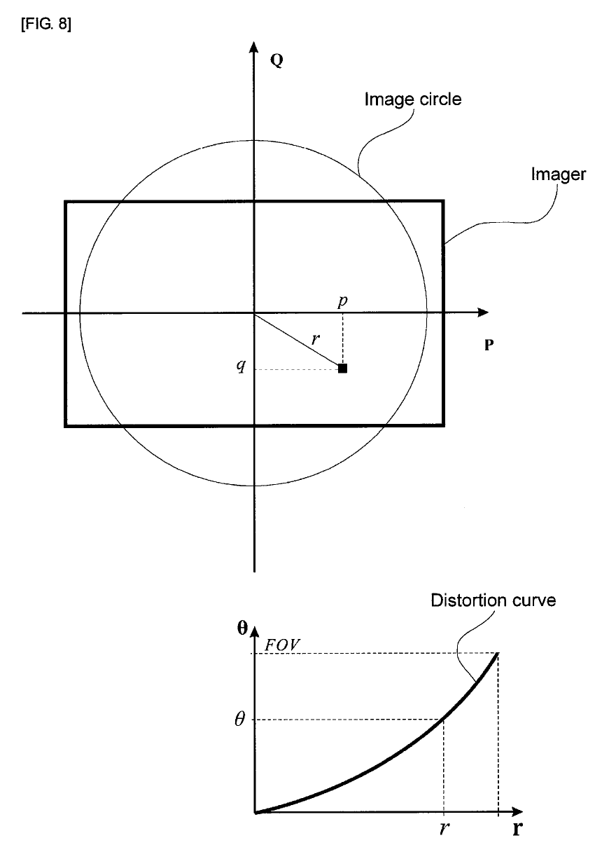

The targets to be captured are placed in the peripheral area of the vehicle as shown in the FIG. 7a. It is assumed that each camera captures at least 2 targets: target A and target B. Although there is no precisely predefined location of the targets with respect to the vehicle, in order to achieve higher precision of calibration it is preferable that the distance between targets A and B in the lateral direction is maximized but still kept within the field of view of the camera unit. For small vehicle a reasonable distance between the targets would be about 2 meters.

The targets A and B are simultaneously captured by the camera unit, and the image is transferred to ECU and saved in the memory as I₁.

Then the vehicle is moved with respect to the targets in the longitudinal direction (along X-axis) by a certain distance. The displacement of the vehicle should be maximized for higher precision of calibration, but the targets must still remain within the FOV of the corresponding cameras (FIG. 7b). For a small size vehicle a reasonable displacement would be about 1.5-2 meters.

The targets are captured in the new location of the vehicle and the image is transferred to ECU and saved in the memory as I₂.

The targets are detected on each of the images I, and 12 using any appropriate state of the art machine vision algorithm, and their coordinates on the imager are stored in the memory as:

p_{1A}, q_{1A}—for image I₁, target A;

p_{1B}, q_{1B}—for image I₁, target B;

p_{2A}, q_{2A}—for image I₂, target A;

p_{2B}, q_{2B}—for image I₂, target B.

Calculation of World Coordinates of the Targets

The coordinates of the targets on the imager are transformed in order to obtain word coordinates of the targets before and after the displacement of the vehicle. Bellow we demonstrate the transformation in general terms, regardless of particular image or target.

Thereafter, chief ray entering the optical system corresponding to a point with the coordinates p, q on the imager, thereafter referred to as chief ray.

First, the distance from a point with the coordinates p, q to the imager's center is calculated:

r=\sqrt{p²+q²} (1)

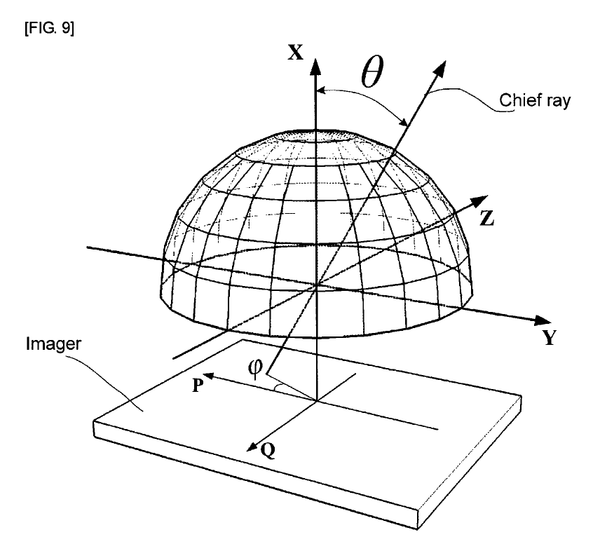

It is well known that wide-angle lenses used in camera system often show significant optical distortion. Therefore r is translated into the spatial angle θ between the optical axis O and chief ray, taking distortion into account. It can be done using a mapping function often referred to as “distortion curve,” and is represented in a form of look-up table, graph or analytical expression. An example of distortion curve is shown in the FIG. 8. Distortion curve is known from the lens system optical design.

The angle φ between the projection of the chief ray on the imager's plane and axis P can be calculated:

φ=tan⁻¹(q/p) (2)

Note that the angles φ and θ define chief ray in the spherical coordinate system whose origin coincides with world coordinate system's origin. FIG. 9 illustrates the spherical coordinate system as well as world coordinate system X Y Z assuming the camera is in normal orientation. Now we can write the linear equation in order to define the same chief ray in world coordinate system, taking into account rotation needed to drive the camera from normal orientation into actual orientation:

$$\frac{x}{a} = \frac{y}{b} = \frac{z}{c} \qquad ( 3 )$$

where parameters

$$( \begin{matrix}a \\ b \\ c\end{matrix} ) = M ( α , β , γ ) \cdot ( \begin{matrix}cos θ \\ sin θ \cdot cos ϕ \\ sin θ \cdot sin ϕ\end{matrix} ) \qquad ( 4 )$$

In this equation, M(α,β,γ) is an affine transform rotation matrix:

$$M ( α , β , γ ) = ( \begin{matrix}cos γ & - sin γ & 0 \\ sin γ & cos γ & 0 \\ 0 & 0 & 1\end{matrix} ) \cdot ( \begin{matrix}cos β & 0 & sin β \\ 0 & 1 & 0 \\ - sin β & 0 & cos β\end{matrix} ) \cdot ( \begin{matrix}1 & 0 & 0 \\ 0 & cos α & - sin α \\ 0 & sin α & cos α\end{matrix} ) \qquad ( 5 )$$

Ground plane equation in world coordinate system is

z=−h (6)

where h is the elevation of the camera over the ground and is known from the camera system design.

Substituting z in the equation (7), we will find the world coordinates of a cross point of chief ray, defined by θ and φ, and ground plane, which is nothing but the world coordinates of the target:

$$x = - \frac{h \cdot a}{c} \\ y = - \frac{h \cdot b}{c} \qquad ( 7 )$$

Substituting p, q in the equations (1) and (2) with the values for the particular image and target, world coordinates for the image I₁ target A (x_{1A},y_{1A}), I₁ target B (x_{1B},y_{1B}), I₂ target A (x_{2A},y_{2A}) and I₂ target B (x_{2B},y_{2B}) are calculated.

Angular Misalignment Calculation

If the rotation angles α, β and γ used to calculate the world coordinates of the targets correspond to the actual camera orientation, then the following equations hold:

Δx_{A}=Δx_{B}

Δy_{A}=0

Δy_{B}=0 (8)

where:

Δx_{A}=x_{1A}−x_{2A}

Δy_{A}=y_{1A}−y_{2A}

Δx_{B}=x_{1B}−x_{2B}

Δy_{B}=y_{1B}−y_{2B} (9)

Based on that, we define the metric used for rotation angles optimization:

Φ(α,β,γ)=(Δx_{A}−Δx_{B})²+Δy_{A}²+Δy_{B}² (10)

However, a number of other metrics can be defined by someone skilled in the art without departure from the scope of the present invention.

By varying αₑᵣᵣ, βₑᵣᵣ and γₑᵣᵣ, such a combination of angles is sought for, that the metric Φ(α,β,γ) is minimized. A number of optimization methods can be employed to provide fast search of optimum angles, for example Gradient Descent or Gauss-Newton optimization method. However, other methods may be used without departure from the scope of the present invention. One may use, for example, minimum metric threshold, minimum angle change threshold, or maximum number of iterations as a termination criterion for iterative optimization methods.

Calibration Steps

Thus, method of camera system calibration consists of the following steps performed individually for each camera incorporated in the system, except for step 2:

Step 1. Capture image I₁, transfer to ECU, save in the memory;

Step 2. Move the vehicle in longitudinal direction by some distance;

Step 3. Capture image I₂, transfer to ECU, save in the memory;

Step 4. Detect targets on the images, obtain (p_{1A}, q_{1A}), (p_{1B}, q_{1B}), (p_{2A}, q_{2A}), (p_{2B}, q_{2B});

Step 5. Initiate α, β, γ with values αₙₒₘ, βₙₒₘ, γₙₒₘ correspondingly;

Step 6. Calculate (θ_{1A},φ_{1A}), (θ_{1B},φ_{1B}), (θ_{2A},φ_{2A}), (θ_{2B}, φ_{2B}) using equations (1), (2), and distortion curve;

Step 7. Calculate M(α,β,γ) with current values of α, β, γ using equation (5);

Step 8. Calculate world coordinates (x_{1A},y_{1A}), (x_{1B},y_{1B}), (x_{2A},y_{1A}), (x_{2B},y_{2B}) using equations (4), (7);

Step 9. Calculate metric Φ(α,β,γ) using equation (10);

Step 10. Update angles α, β, γ using optimization method;

Step 11. If the termination criterion specific for the optimization method is met,—go to Step 13;

Step 12. Go to Step 7;

Step 13. Calculate misalignment angles αₑᵣᵣ=α−αₙₒₘ, βₑᵣᵣ=β−βₙₒₘ, yₑᵣᵣ=γ−γₙₒₘ;

Step 14. STOP.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

A lot of other embodiments fall within the scope of the present inventive concept.

### An Example of the Preferred Embodiment

Thereafter, an example of preferable embodiment of the invention is demonstrated.

Let the predefined parameters be as follows:
nominal angles

αₙₒₘ=0°, βₙₒₘ=20°, γₙₒᵣ=0°
elevation of the camera over the ground (m)

h=0.8
distortion curve is linear and defined in analytical form:

$$θ = \frac{r}{1140.8}$$

After capturing the images, the targets are detected and their coordinates (in micrometers) on the imager are determined:

| Target | p, μm | q, μm |
|---|---|---|
| 1A | −753.41 | 148.82 |
| 1B | 1071.9 | −120.14 |
| 2A | −1333.9 | −177.25 |
| 2B | 1562.9 | −632.11 |

The following parameters are calculated:

| Target | r, μm | θ, deg. | φ, deg. |
|---|---|---|---|
| 1A | 767.97 | 38.5698 | 168.8263 |
| 1B | 1078.6 | 54.1713 | −6.3951 |
| 2A | 1345.6 | 67.5816 | 187.5692 |
| 2B | 1685.9 | 84.6707 | −22.0207 |

The optimal angles are determined using Quasi-Newton Line Search method. The termination criterion is minimum metric threshold: Φ(α,β,γ)<10⁻⁵. The progress on each iteration is shown in the table:

| | Rotation angles, deg | | | Metric |
|---|---|---|---|---|
| Iteration # | α | β | γ | Φ (α, β, γ) |
| 0 | 0 | 20 | 0 | 2.27065 |
| 1 | 4.6360 | 25.6665 | −0.1452 | 0.116542 |
| 2 | 4.6171 | 25.3269 | −0.2051 | 0.0959381 |
| 3 | 4.6244 | 22.1890 | −0.8426 | 0.0475501 |
| 4 | 4.7519 | 23.4896 | −0.6551 | 0.0256586 |
| 5 | 4.8388 | 23.1996 | −0.7799 | 0.0214383 |
| 6 | 5.0270 | 22.9072 | −1.0212 | 0.0179598 |
| 7 | 5.1500 | 22.8589 | −1.2184 | 0.016015 |
| 8 | 5.3062 | 22.8974 | −1.6307 | 0.0129291 |
| 9 | 5.3659 | 22.9739 | −2.1126 | 0.00986254 |
| 10 | 5.3377 | 23.0725 | −3.0325 | 0.00492538 |
| 11 | 5.1902 | 23.0870 | −3.8327 | 0.00135723 |
| 12 | 5.0413 | 23.0368 | −4.1103 | 0.000123618 |
| 13 | 5.0003 | 23.0080 | −4.0457 | 4.96612e−006 |

On the 13-th iteration the termination criterion Φ(α,β,γ)<10⁻⁵ is met, therefore the optimization procedure stops.

Finally, the sought misalignment angles (in deg.) are calculated:

αₑᵣᵣ=5.0003−0=5.0003

βₑᵣᵣ=23.008−20=3.008

γₑᵣᵣ=−4.0457−0=−4.0457

What is claimed is:

1. Method of calibrating a camera equipped on vehicle, comprising the steps:
a) capturing a first image featuring at least two targets with a camera attached to each side of the vehicle, the targets being placed in the peripheral area of the vehicle;
b) displacing the vehicle in the longitudinal direction without moving the targets;
c) capturing a second image featuring the targets at the displaced position;
d) detecting the targets on the captured first and second images;
e) calculating world coordinates of the targets based on the captured images; and
f) searching for misalignment angles while optimizing a metric function based on the calculated world coordinates of the targets.

2. The method according to claim 1, wherein the targets are placed or painted on the ground in the peripheral area of the vehicle.

3. The method according to claim 1, wherein a distance between the two targets adjacent to each other in the lateral direction is maximized but still kept within a field of view of the camera.

4. The method according to claim 1, wherein the vehicle is configured to be displaced on its own wheels or on a conveyor or other equivalent means.

5. The method according to claim 1, wherein step e) comprises calculating spherical coordinates of the chief ray entering an optical unit of the camera and world coordinates of its cross point with the ground plane.

6. The method according to claim 5, further comprising adjusting chief ray spherical coordinates according to the lens optical distortion.

7. The method according to claim 1, wherein step f) comprises starting the search with nominal rotation angles of a camera.

8. Apparatus for calibrating a camera equipped on vehicle, comprising:
a plurality of camera units attached to four sides of vehicle, each camera unit being configured to capture a image featuring at least two targets; and
a electronic control unit configured to form a single top view by synthesizing the images captured by each of the plurality of camera units, wherein the electronic control unit determines an angular misalignment of vehicle with a method comprising the steps:
a) capturing a first image featuring at least two targets per camera unit attached to a side of the vehicle, the targets being placed in the peripheral area of the vehicle;
b) displacing the vehicle in the longitudinal direction without moving the targets;
c) capturing a second image featuring the targets at the displaced position;
d) detecting the targets on the captured first and second images;
e) calculating world coordinates of the targets based on the captured images; and
f) searching for misalignment angles while optimizing a metric function based on the calculated world coordinates of the targets.

9. The apparatus according to claim 8, wherein the electronic control unit is incorporated into an electronic control unit already implemented in the vehicle.

10. The apparatus according to claim 8, wherein the electronic control unit is a stand-alone device separated from an electronic control unit already implemented in the vehicle.

11. Method for determining an angular misalignment of a camera equipped on vehicle, comprising:
a) capturing a first image featuring at least two targets placed at one side in the peripheral area of the vehicle at a first position of the vehicle;
b) capturing a second image featuring the targets at a second position away from the first position of the vehicle in the longitudinal direction;
c) detecting the targets on the first and second images and obtaining their coordinates on an imager;
d) initiating rotation angles α, β, γ with nominal angle values, respectively;
e) calculating angles φ and θ for each of the targets at the first and second positions, the angles φ and θ defining chief ray in the spherical coordinate system whose origin coincides with world coordinate system's origin;
f) calculating an affine transformation rotation matrix with current values of α, β, γ;
g) calculating world coordinates for the targets at the first and second positions using the angles θ and φ, and elevation of the camera over the ground;
h) calculating metric used for rotation angles optimization using the calculated world coordinates;
i) updating the angles α, β, γ with optimization method until a termination criterion specific for the optimization method is met; and
j) calculating misalignment angles from the differences between the undated angles α, β, γ meeting the termination criterion specific and the nominal rotation angles.

12. Electronic control unit for determining an angular misalignment of a camera equipped on vehicle, the electronic control unit being configured to control and/or perform the steps comprising:
a) at a first position of the vehicle and at a second position away from the first position of the vehicle in the longitudinal direction, capturing first and second images each featuring at least two targets placed at one side in the peripheral area of the vehicle, and in turn detecting the targets on the first and second images and then obtaining their coordinates on an imager;
b) initiating rotation angles α, β, γ with nominal angle values, respectively;
c) calculating angles φ and θ for each of the targets at the first and second positions, the angles φ and θ defining chief ray in the spherical coordinate system whose origin coincides with world coordinate system's origin;
d) calculating an affine transformation rotation matrix with current values of α, β, γ;
e) calculating world coordinates for the targets at the first and second positions using the angles θ0 and φ, and elevation of the camera over the ground;
f) calculating metric used for rotation angles optimization using the calculated world coordinates;
g) updating the angles α, β, γ with optimization method until a termination criterion specific for the optimization method is met; and
h) calculating misalignment angles from the differences between the undated angles α, β, γ meeting the termination criterion specific and the nominal rotation angles.

13. The electronic control unit according to claim 12, wherein the electronic control unit is incorporated into an electronic control unit already implemented in the vehicle.

14. The electronic control unit according to claim 12, wherein the electronic control unit is a stand-alone device separated from an electronic control unit already implemented in the vehicle.

15. The electronic control unit according to claim 12, wherein the targets are placed or painted on the ground in the peripheral area of the vehicle.

16. The electronic control unit according to claim 15, wherein a distance between the two targets adjacent to each other in the lateral direction is maximized but still kept within a field of view of the camera.
